(19) United States
(12) Patent Application Publication
(10) Pub. No.: US 2026/0120310 A1
(43) Pub. Date: Apr. 30, 2026

(54) IMAGE PROCESSING METHOD, DEVICE, AND MEDIUM

(71) Applicant: Beijing Zitiao Network Technology Co., Ltd., Beijing (CN)

(72) Inventor: Tianyi XIAO, Beijing (CN)

(21) Appl. No.: 19/374,909

(22) Filed: Oct. 30, 2025

(30) Foreign Application Priority Data
Oct. 30, 2024 (CN) 202411535298.6

(51) Int. Cl. G06T 7/70; G06V 10/60

(52) U.S. Cl. CPC G06T 7/70; G06V 10/60

(57) ABSTRACT

An image processing method, an electronic device, and a storage medium are provided. The method includes: obtaining an image to be processed in response to an image processing request, wherein the image to be processed includes a first object; determining first distance values from a plurality of image pixels in the image to be processed to an object boundary of the first object, and determining a first pixel corresponding to the first object from the plurality of image pixels according to the first distance values; and determining a shadow pixel value for the first object acting on the first pixel according to a preset color, determining a first image according to the shadow pixel value corresponding to the first pixel, and displaying the first image.

### CROSS-REFERENCE TO APPLICATION

This application claims priority to Chinese Patent Application No. 202411535298.6, filed on October 30, 2024, the entire disclosure of which is incorporated herein by performance as part of the present disclosure.

### TECHNICAL FIELD

Embodiments of the present disclosure relate to the field of computer processing technology, and in particular, to an image processing method, a device, and a medium.

### BACKGROUND

In some image processing scenarios, in order to make an image exhibit more realistic light and shadow effect, the shadow effect may be added to the image to simulate, in the image, the shadow of an object that light shines on.

In the related art, there are two ways of adding the shadow effect to an image. One is to add the shadow to an object included in the image by means of a shadow camera provided for a three-dimensional rendering space and using a real-time illumination algorithm. However, the implementation process of such a real-time rendering way is complex and a large number of three-dimensional spatial operations are needed, which may easily lead to a delay in shadow effect rendering. Moreover, the shown shadow edge is sharp, and it is also difficult to naturally transition from the shadow color to the illumination color. In short, this way has poor shadow presenting effect and low shadow generation efficiency. The other way is to generate shadow animation sequence frames in advance by an offline rendering application and present the shadow in the image by playing the shadow animation sequence frames. However, such an offline rendering way requires occupation of more internal memory space.

### SUMMARY

Embodiments of the present disclosure provide an image processing method, an electronic device, and a storage medium.

In the first aspect, embodiments of the present disclosure provide an image processing method, comprising: obtaining an image to be processed in response to an image processing request, wherein the image to be processed comprises a first object; determining first distance values from a plurality of image pixels in the image to be processed to an object boundary of the first object, and determining a first pixel corresponding to the first object from the plurality of image pixels according to the first distance values; and determining a shadow pixel value for the first object acting on the first pixel according to a preset color, determining a first image according to the shadow pixel value corresponding to the first pixel, and displaying the first image.

In at least one embodiment, the determining first distance values from a plurality of image pixels in the image to be processed to an object boundary of the first object comprises: determining a signed distance field function corresponding to the first object, and determining the first distance values from the plurality of image pixels in the image to be processed to the object boundary of the first object according to the signed distance field function, wherein the signed distance field function is associated with a boundary shape of the first object.

In at least one embodiment, the determining a signed distance field function corresponding to the first object comprises: obtaining a preset signed distance field function corresponding to the first object; or determining an object boundary function corresponding to the first object according to the boundary shape of the first object and a preset shape function, and constructing the signed distance field function according to the object boundary function.

In at least one embodiment, the constructing the signed distance field function according to the object boundary function comprises: when the object boundary function comprises a plurality of preset shape functions, constructing a signed distance field function according to each of the plurality of preset shape functions; and the determining the first distance values from the plurality of image pixels in the image to be processed to the object boundary of the first object according to the signed distance field function comprises: determining signed distance values from the plurality of image pixels in the image to be processed to the object boundary of the first object according to each of the plurality of signed distance field functions; and for each of the plurality of image pixels, determining a first distance value corresponding to the image pixel according to the signed distance values corresponding to the plurality of signed distance field functions.

In at least one embodiment, the determining an object boundary function corresponding to the first object according to the boundary shape of the first object and a preset shape function comprises at least one of following operations: in response to obtaining a preset shape function in conformity with the boundary shape of the first object, determining the preset shape function as the object boundary function corresponding to the first object; in response to obtaining no preset shape function in conformity with the boundary shape of the first object, transforming the preset shape function to the object boundary function corresponding to the first object by adjusting at least one parameter of the preset shape function according to the boundary shape of the first object; and in response to obtaining no preset shape function in conformity with the boundary shape of the first object, obtaining the plurality of preset shape functions which are splicable to obtain the boundary shape of the first object, and determining the plurality of preset shape functions as the object boundary function corresponding to the first object.

In at least one embodiment, the determining a shadow pixel value for the first object acting on the first pixel according to a preset color comprises: determining a shadow weighted value according to a first distance value corresponding to the first pixel, and determining the shadow pixel value for the first object acting on the first pixel according to a display pixel value of the first pixel in the image to be processed, the preset color, and the shadow weighted value.

In at least one embodiment, the determining a first pixel corresponding to the first object from the plurality of image pixels according to the first distance values comprises: determining an image pixel

corresponding to the first distance value within a preset distance range as the first pixel corresponding to the first object.

In at least one embodiment, after the determining a shadow pixel value for the first object acting on the first pixel according to a preset color, the image processing method further comprises: when the image to be processed comprises a plurality of first objects and there is one first pixel corresponding to the plurality of first objects, for the first pixel corresponding to the plurality of first objects, determining a maximum of shadow pixel values for the plurality of first objects acting on the first pixel as the shadow pixel value corresponding to the first pixel, or determining a sum of the shadow pixel values for the first objects acting on the first pixel as the shadow pixel value corresponding to the first pixel.

In the second aspect, embodiments of the present disclosure provide an electronic device comprising one or more processors, and a storage apparatus configured to store one or more programs, the one or more programs, when executed by the one or more processors, cause the one or more processors to implement the above image processing method according to any one embodiment.

In the third aspect, Embodiments of the present disclosure provide a non-transitory computer-readable storage medium, storing a computer program which, when executed by a processor, causes the above image processing method according to any one embodiment to be implemented.

### BRIEF DESCRIPTION OF DRAWINGS

The above and other features, advantages and aspects of different embodiments of the present disclosure will become more apparent from the accompanying drawings and the following specific embodiments. Identical or similar reference numerals indicate identical or similar elements throughout the drawings. It will be understood that the drawings are illustrative, and components and elements are not necessarily drawn to scale.

FIG. 1 is a flowchart of an image processing method provided by an embodiment of the present disclosure;

FIG. 2 is a flowchart of another image processing method provided by an embodiment of the present disclosure;

FIG. 3 is a structural schematic diagram of an image processing apparatus provided by an embodiment of the present disclosure; and

FIG. 4 is a structural schematic diagram of an electronic device provided by an embodiment of the present disclosure for implementing the embodiments of the present disclosure.

### DETAILED DESCRIPTION

Embodiments of the present disclosure will be described below in more detail with reference to the accompanying drawings. While the accompanying drawings show some embodiments of the present disclosure, it will be understood that the present disclosure may be implemented in various forms and should not be construed as being limited to the embodiments set forth herein. Rather, these embodiments are provided so that the present disclosure can be understood more thoroughly and comprehensively. It should

be understood that the accompanying drawings and the embodiments of the present disclosure are only used as examples, and are not intended to limit the protection scope of the present disclosure.

It will be understood that steps described in the method implementations of the present disclosure may be performed in different orders and/or concurrently. In addition, the method implementations may include additional steps and/or the steps shown may be omitted. The scope of the present disclosure is not limited in this aspect.

As used herein, the term “include” and variants thereof are open words and should be construed as “including but not limited to”. The term “based on” means “at least in part based on”. The term “one embodiment” represents “at least one embodiment”; the term “another embodiment” represents “at least one further embodiment”; and the term “some embodiments” represents “at least some embodiments”. The relevant definitions of other terms will be given in the following descriptions.

It needs to be noted that terms such as "first" and "second" are used for distinguishing between different apparatuses, modules or units rather than defining the sequence or interdependent relation of functions performed by such apparatuses, modules or units.

It needs to be noted that terms such as “a/an” and “a plurality of” used herein are illustrative and non-limiting. It will be understood by a person skilled in the art that “a/an” shall be construed as “one or more” unless specified otherwise.

Names of messages or information exchanged between a plurality of apparatuses in embodiments of the present disclosure are only used for the purpose of description and not meant to limit the scope of these messages or information.

It will be understood that before using the technical solutions disclosed in various embodiments of the present disclosure, a user should be notified of a type, a range of use, a usage scenario, etc. of personal information involved in the present disclosure in an appropriate manner in accordance with relevant laws and regulations, and these should be authorized by the user.

For example, in response to receiving an active request from a user, prompt information is sent to the user to explicitly prompt the user that the operation the user requests to perform will require to acquire and use the personal information of the user. Thus, the use can independently select, according to the prompt information, whether or not to provide the personal information to software or hardware such as an electronic device, an application, a server or a storage medium that performs the operations of the technical solutions of the present disclosure.

As an alternative but non-limiting implementation, in response to receiving an active request from a user, a manner of sending a prompt information to the user may be, for example, using a pop-up window in which the prompt information may be presented in the form of text. Furthermore, the pop-up window may also carry option controls for a user to select to “agree” or “disagree” with providing personal information to an electronic device.

It will be understood that the processes of notifying of and authorizing by a user described above are merely exemplary and do not constitute a limitation on the implementations of the present disclosure, and other manners meeting relevant laws and regulations may also be applied to the implementations of the present disclosure.

It will be understood that data (including but not limited to data itself, and the acquisition and use of data) involved in the present technical solutions should follow corresponding laws and regulations and requirements of relevant stipulations.

FIG. 1 is a flowchart of an image processing method provided by an embodiment of the present disclosure. This embodiment of the present disclosure is applicable to a scenario of adding the shadow effect to an object in an image. The image processing method may be performed by an image processing apparatus that may be implemented in the form of software and/or hardware and optionally implemented by an electronic device. The electronic device may be a mobile terminal, a personal computer (PC), a server, or the like. As shown in FIG. 1, the image processing method of the present embodiment may include the following steps.

S110: obtaining an image to be processed in response to an image processing request, wherein the image to be processed includes a target object (e.g. a first object).

In an embodiment of the present disclosure, the image processing request is used for requesting to start performing the operation of processing the image to be processed. The image to be processed may be construed as an image to be added with the shadow effect. The image processing request may be generated in a plurality of ways. Exemplarily, the image processing request may be triggered and generated by at least one of the following ways: triggered and generated by a control triggering operation on a preset image processing control; generated when the image to be processed meets a preset shadow adding condition; generated when a preset trigger event is detected; generated when an image showing time meets a preset shadow adding time, and so on. The shadow adding condition may include, but is not limited to, the image to be processed including an image content of a preset type, and the like. The target object may be construed as an object needing to be added with the shadow effect. Specifically, the target object may be an object of a preset type in the image to be processed. The target object may be one or more objects in the image to be processed. Exemplarily, the target image may be one or more of a book, a person, a plant, and a building in the image to be processed. The target object may also be an object in a preset shape in the image to be processed.

Optionally, the image to be processed may be at least one of an image uploaded based on an image uploading control, an image shot based on an image shooting control, a received image transmitted by a target application or a target interface, etc. The image to be processed may also be at least one of an image obtained after processing an uploaded image, an image obtained after processing a shot image, an image obtained after processing a received image transmitted, or other image. It needs to be noted that the way of processing an image may be processing the image based on a preset image processing flow, or processing the image based on a received image processing flow, or the like. The image processing flow may include at least one image processing way. When the image processing flow includes a plurality of image processing ways, the plurality of image processing ways may be combined according to a preset processing logic.

As an optional technical solution of the embodiments of the present disclosure, obtaining, in response to an image processing request, an image to be processed may include: obtaining a set original image in response to an image setting operation; and determining the image to be processed according to the original image in response to a processing triggering operation on the original image.

S120: determining target distance values (e.g. first distance values) from a plurality of image pixels in the image to be processed to an object boundary of the target object, and determining a target pixel (e.g. a first pixel) corresponding to the target object from the plurality of image pixels according to the target distance values.

The object boundary of the target object may be construed as a display boundary, presented in the image to be processed, between the target object and an object other than the target object in the image to be processed. In other words, the object boundary of the target object may be a boundary of a display region of the target object in the image to be processed.

Specifically, the target distance values of the plurality of image pixels from the object boundary of the target object may be target distance values of the image pixels in the image to be processed outside the object boundary of the target object from the object boundary, or a target distance value of each image pixel in the image to be processed from the object boundary, wherein a target distance value corresponding to a pixel inside the object boundary may be set to a preset value or provided with a sign opposite to that of a target distance value corresponding to a pixel outside the object boundary of the target object. For example, a target distance value corresponding to a pixel inside the object boundary may be set to a negative number, and a target distance value corresponding to an image pixel outside the object boundary of the target object may be set to a positive number.

As an optional implementation of the embodiments of the present disclosure, determining a target pixel corresponding to the target object from the plurality of image pixels according to the target distance values may specifically be: determining the target pixel corresponding to the target object from the plurality of image pixels according to the target distance values and a preset distance range. More specifically, the image pixel corresponding to the target distance value within the preset distance range may be determined as the target pixel corresponding to the target object. In other words, when the target distance value is within the preset distance range, the image pixel corresponding to the target distance value is obtained as the target pixel in the image to be processed. The target pixel may be construed as an image pixel in the image to be processed that needs to be added with the shadow effect corresponding to the target object.

S130: determining a shadow pixel value for the target object acting on the target pixel according to a preset color, determining a target image (e.g. a first image) according to the shadow pixel value corresponding to the target pixel, and displaying the target image.

The preset color may be construed as a preset basic color presented in the shadow area. The shadow pixel value may be obtained after adjustment on the basis of the preset color. The shadow pixel value may be construed as a color value of the target pixel displayed in the target image.

Optionally, determining, according to the preset color, the shadow pixel value for the target object acting on the target pixel includes: for each target pixel, determining the shadow pixel value for the target object acting on the target pixel according to the preset color of the target pixel and the display color value of the target pixel in the image to be processed. Specifically, the preset color of the target pixel and the display color value of the target pixel in the image to be processed may be fused in a preset fusion way to obtain the shadow pixel value for the target object acting on the target pixel. The preset fusion way may include, but is not limited to, multiplication, weighted multiplication, summation, or weighted summation, etc. With the present technical solution, the shadow effect of the target pixel presented in the target image may be made fitter with the original display effect of the image to be processed such that the shadow effect in the target image is presented more realistically to improve the display effect of the target image.

As an optional technical solution of the embodiments of the present disclosure, more specifically, a shadow weighted value may be determined according to the target distance value corresponding to the target pixel, and the shadow pixel value for the target object acting on the target pixel may be determined according to a display pixel value of the target pixel in the image to be processed, the preset color, and the shadow weighted value. With the present technical solution, the shadow pixel value corresponding to the target pixel is associated with the target distance value corresponding to the target pixel so that the shadow effect of the target object can be displayed more hierarchically.

The display color value of the target pixel in the image to be processed may be construed as a color value of that target pixel displayed in the image to be processed, i.e., the color value of that target pixel displayed in the image to be processed before the shadow effect is added. A magnitude of the shadow weighted value corresponds to the shade intensity of the shadow presented by the target pixel. When the shadow value corresponding to the target pixel is one, the color (i.e., the shadow pixel value) of the target pixel presented in the target image is the preset color. When the shadow value corresponding to the target pixel is zero, the color (i.e., the shadow pixel value) of the target pixel presented in the target image is the display color of the target pixel in the image to be processed, i.e., the color originally presented by the target pixel.

Optionally, determining the shadow weighted value according to the target distance value corresponding to the target pixel specifically includes: determining the shadow weighted value according to the target distance value and a distance boundary value corresponding to the target pixel. The distance boundary value may be a preset distance value for controlling a transition range of the shadow. The greater the distance boundary value, the wider the transition range of the shadow. As an optional implementation of the embodiments of the present disclosure, determining the shadow weighted value according to the target distance value and the distance boundary value corresponding to the target pixel may include: using a ratio of a difference between the distance boundary value and the target distance value to the distance boundary value as the shadow weighted value.

As an optional technical solution of the embodiments of the present disclosure, after determining the shadow pixel value for the target object acting on the target pixel according to the preset color, the image processing method further includes: when the image to be processed includes a plurality of target objects and there is one target pixel corresponding to the plurality of target objects, for the same one target pixel corresponding to the plurality of target objects, determining a maximum of shadow pixel values for the plurality of target objects acting on the target pixel as the shadow pixel value corresponding to the target pixel; or when the image to be processed includes a plurality of target objects and there is one target pixel corresponding to the plurality of target objects, for the same one target pixel corresponding to the plurality of target objects, determining a sum of the shadow pixel values for the target objects acting on the target pixel as the shadow pixel value corresponding to the target pixel.

The same one target pixel corresponding to the plurality of target objects may be construed as the shadow areas corresponding to the plurality of target objects overlapping. In other words, there is a repeated image pixel among the target pixels corresponding to the plurality of target objects. The target pixel corresponding to the plurality of target objects is a repeated pixel among the target pixels corresponding to the plurality of target objects. In this situation, the repeated pixel may have a plurality of shadow pixel values determined according to different target objects, respectively. The shadow pixel value of the repeated pixel presented in the target image may be the maximum of the plurality of shadow pixel values corresponding to the repeated pixel, or the sum obtained by summing the plurality of shadow pixel values.

For example, taking the target pixel of a shadow overlap area of a plurality of book pages as an example, the shadow pixel value for each book page acting on the target pixel may be calculated, and a maximum of a plurality of shadow pixel values may be used as the final shadow pixel value of the target pixel.

With the present technical solution, the addition of the shadow effect to the plurality of target objects in the image to be processed is supported. Especially when the plurality of target objects overlap, the effect that the shadow areas of the plurality of target objects overlap can be presented.

According to the technical solutions of the embodiments of the present disclosure, the image to be processed including the target object is obtained in response to the image processing request. After the image processing request is received, the image processing flow can be automatically started to obtain the image needing to be processed. The target distance values from the plurality of image pixels in the image to be processed to the object boundary of the target object are then determined, and the target pixel corresponding to the target object is determined from the plurality of image pixels according to the target distance values. The target pixel needing to be added with the shadow effect in the image to be processed can be determined merely by determining the target distance value of the image pixel from the object boundary of the target object in the two-dimensional space. The target pixel can be determined simply, rapidly, and accurately. Finally, the shadow pixel value for the target object acting on the target pixel is determined according to the preset color, and the target image is determined according to the shadow pixel value corresponding to the target pixel and displayed. It is supported that the shadow effect is flexibly set at the target pixel. The target image including the shadow effect is generated. The image display effects are enriched. The technical problems of complex shadow effect generation way, occupation of large internal memory space, low shadow generation efficiency, and the like in the related art are solved. The effects of reducing the shadow generation complexity of the target object, saving the internal memory and the computing power space, expanding the range of application, simplifying the image processing flow, and enhancing the image processing experience are achieved.

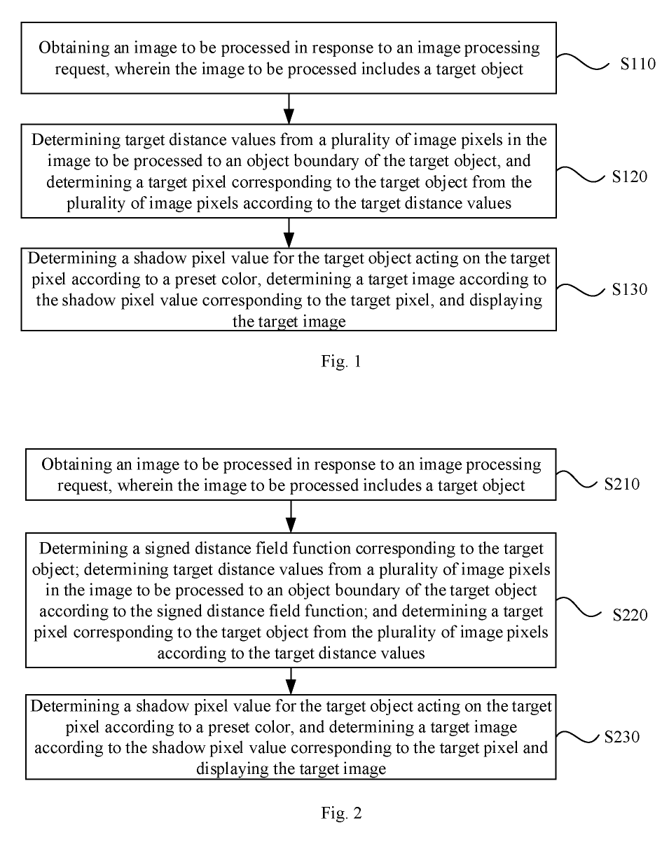

FIG. 2 is a flowchart of another image processing method provided by an embodiment of the present disclosure. The technical solution of the present embodiment is to further detail, on the basis of the above embodiments, the way of determining the target distance values from the plurality of image pixels in the image to be processed to the object boundary of the target object. Optionally, a signed distance field function corresponding to the target object is determined, and the target distance values from the plurality of image pixels in the image to be processed to the object boundary of the target object are determined according to the signed distance field function, wherein the signed distance field function is associated with a boundary shape of the target object. The specific implementation may be as described as in the present embodiment. The technical features identical or similar to those in the foregoing embodiments will not be repeatedly described. As shown in FIG. 2, the method of this embodiment may specifically include the following steps.

S210: obtaining an image to be processed in response to an image processing request, wherein the image to be processed includes a target object.

S220: determining a signed distance field function corresponding to the target object; determining target distance values from a plurality of image pixels in the image to be processed to an object boundary of the target object according to the signed distance field function; and determining a target pixel corresponding to the target object from the plurality of image pixels according to the target distance values.

In an embodiment of the present disclosure, the signed distance field (SDF) function is associated with the boundary shape of the target object. An input to the signed distance field function is a position of any point within a two-dimensional plane, and an output value is a distance value of the input point to the boundary of a specific set. By constructing different functions, the shape of the boundary of the set can be controlled, to be such as a circle, a square, or a triangle. Therefore, in the two-dimensional plane, the shadow in a particular shape can be drawn by SDF, and the color shade of the shadow can be determined according to the magnitude of the calculated target distance value.

Specifically, determining the target distance values from the plurality of image pixels in the image to be processed to the object boundary of the target object according to the signed distance field function includes: determining, according to the signed distance field function, signed distance values from the plurality of image pixels in the image to be processed to the object boundary of the target object, and determining, according to the signed distance values corresponding to the image pixels, the target distance values corresponding to the image pixels. With the present technical solution, compared with the way of adding the shadow to an object included in an image by means of a shadow camera provided for a three-dimensional rendering space and using a real-time illumination algorithm, large computing power space is saved. The signed distance values from the plurality of image pixels in the image to be processed to the object boundary of the target object can be calculated rapidly with two-dimensional image information.

Taking a rectangle as an example (the same applies to other shapes, such as a circle and a parallelogram), a target distance value corresponding to an image pixel inside the rectangle is less than zero, a target distance value corresponding to an image pixel at the edge of the rectangle is equal to zero, and a target distance value corresponding to an image pixel outside the rectangle is greater than zero. Moreover, the greater the distance from the boundary of the rectangle, the greater the target distance value.

As an optional implementation of the embodiments of the present disclosure, specifically, determining the signed distance field function corresponding to the target object may include: obtaining a preset signed distance field function corresponding to the target object. Specifically, a signed distance field function corresponding to a plurality of preset shapes may be preset. Further, obtaining the preset signed distance field function corresponding to the target object may include: determining and obtaining, according to the shape of the target object, the preset signed distance field function corresponding to the target object. The present technical solution is especially suitable for the case in which the shape of the target object has been determined, and can determine the signed distance field function corresponding to the target object simply and rapidly. Moreover, compared with the storage of the shadow animation sequence frames, the storage of the signed distance field function does not need to occupy too much internal memory space such that the occupation of the computing power resources by shadow processing is reduced.

As an optional implementation of the embodiments of the present disclosure, specifically, determining the signed distance field function corresponding to the target object may include: determining, according to the boundary shape of the target object and a preset shape function, an object boundary function corresponding to the target object, and constructing, according to the object boundary function, the signed distance field function. The boundary shape of the target object may be construed as the shape of the object boundary of the target object. The present technical solution may be suitable for the case where the shadow is added to the target objects in a plurality of shapes. The object boundary function corresponding to the target object is determined by the preset shape function. The object boundary function corresponding to the target object can be determined rapidly. The signed distance field function is then constructed according to the object boundary function. Flexible construction of the signed distance field function can be realized to expand the range of the target objects that the signed distance field function is applicable to.

As an optional implementation of the embodiments of the present disclosure, specifically, constructing, according to the object boundary function, the signed distance field function may include: constructing a signed distance field function according to each of the preset shape functions in response to the object boundary function including a plurality of preset shape functions. In other words, when the boundary shape of the target object needs to be obtained by combining a plurality of sub-shapes, the object boundary function needs to be constructed with the plurality of preset shape functions. It needs to be noted that the plurality of sub-shapes for constituting the boundary shape of the target object, when combined into the boundary shape of the target object, may have an overlap area. Exemplarily, the preset shape function may include a rectangular function corresponding to the rectangular shape. When the boundary shape of the target object is a trapezoid, the object boundary function may be constructed with shape functions corresponding to two parallelograms. The shape function corresponding to the parallelogram may be obtained by adjusting a parameter of the rectangular function. That is, the change of the shadow shape can be controlled by controlling a parameter of the signed distance field function.

Further, determining, according to the signed distance field function, the target distance values from the plurality of image pixels in the image to be processed to the object boundary of the target object includes: determining, according to each signed distance field function, signed distance values from the plurality of image pixels in the image to be processed to the object boundary of the target object; and for a single image pixel, determining, according to the signed distance values corresponding to the plurality of signed distance field functions, the target distance value corresponding to the image pixel. Specifically, determining, according to the signed distance values corresponding to the plurality of signed distance field functions, the target distance value corresponding to the image pixel may include: determining a maximum of the signed distance values corresponding to the plurality of signed distance field functions as the target distance value corresponding to the image pixel. Thus, the shadow pixel value for the target object acting on the target pixel can be determined according to the preset color. With the present technical solution, it can be avoided that the overlap of the sub-shapes constituting the boundary shape of the target object affects the shadow effect such that the determined shadow shape is fitter with the actual light and shadow effect of the target object.

As an optional implementation of the embodiments of the present disclosure, specifically, determining, according to the boundary shape of the target object and the preset shape function, the object boundary function corresponding to the target object includes: when a preset shape function in conformity with the boundary shape of the target object is obtained, determining the preset shape function as the object boundary function corresponding to the target object. That is, the preset shape function in conformity with the boundary shape of the target object is determined as the object boundary function corresponding to the target object. In this case, the object boundary function of the target object can be determined rapidly by the preset shape function, and then the signed distance field function in conformity with the boundary shape of the target object can be constructed so as to determine the shadow shape in conformity with the boundary shape of the target object.

As an optional implementation of the embodiments of the present disclosure, specifically, determining, according to the boundary shape of the target object and the preset shape function, the object boundary function corresponding to the target object includes: when a preset shape function in conformity with the boundary shape of the target object is obtained, transforming, according to the boundary shape of the target object, the preset shape function to the object boundary function corresponding to the target object. That is, at least one parameter of the preset shape function can be adjusted according to the boundary shape of the target object to obtain a shape function in conformity with the boundary shape of the target object, i.e., the object boundary function corresponding to the target object. A function parameter of the signed distance field function is set dynamically to simulate, in a two-dimensional plane, a dynamic change of a projection of a three-dimensional object when moving.

In an embodiment of the present disclosure, the transformation of the preset shape function includes the transformation of at least one parameter of a position, a size, a rotation angle, and an inclination degree of a preset shape, etc. By transforming the preset shape function, the shadow shape may be fit with the shape of the target object.

Taking a book as an example, when a page of the book is parallel to the two-dimensional plane, the shadow shape is the shape of the page. After the page is turned, since the angles of the page to the two-dimensional plane and the light source are changed, the shape of the projection of the page will change accordingly. At this point, the original shape of the page can be stretched by modifying the parameters of the signed distance field function such that the shape of the page is fit with the shape of the projection generated after the page is turned.

As an optional implementation of the embodiments of the present disclosure, specifically, determining, according to the boundary shape of the target object and the preset shape function, the object boundary function corresponding to the target object includes: when no preset shape function in conformity with the boundary shape of the target object is obtained, obtaining a plurality of preset shape functions which are splicable to obtain the boundary shape of the target object, and determining the plurality of preset shape functions as the object boundary function corresponding to the target object. With the present technical solution, according to the combination with the preset shape functions, it is realized that the shadow effect is added to the target object in more shapes in the image to be processed such that the addition of the shadow effect is more flexible. This is applicable to more scenarios.

S230: determining a shadow pixel value for the target object acting on the target pixel according to a preset color, and determining a target image according to the shadow pixel value corresponding to the target pixel and displaying the target image.

In an embodiment of the present disclosure, when the object boundary function corresponding to the target object is determined with the plurality of preset shape functions, the target pixel corresponding to each object boundary function may be determined, and the shadow pixel value corresponding to each target pixel is determined. For a repeated pixel of the target pixels corresponding to the plurality of object boundary functions, the maximum of the shadow pixel values of the repeated pixel determined according to the plurality of object boundary function may be determined as the shadow pixel value corresponding to the target pixel.

With the technical solutions of the embodiments of the present disclosure, the signed distance field function corresponding to the target object is determined and associated with the boundary shape of the target object such that the shadow area matching the boundary shape of the target object is determined. The target distance values from the plurality of image pixels in the image to be processed to the object boundary of the target object are determined according to the signed distance field function. The target distance values corresponding to the plurality of image pixels in the image to be processed can be determined rapidly without complex three-dimensional spatial operations. A relative positional relationship between the plurality of image pixels in the image to be processed and the target object is represented effectively so as to conveniently and rapidly determine the image pixel in the image to be processed that needs to be added with the shadow effect corresponding to the target object.

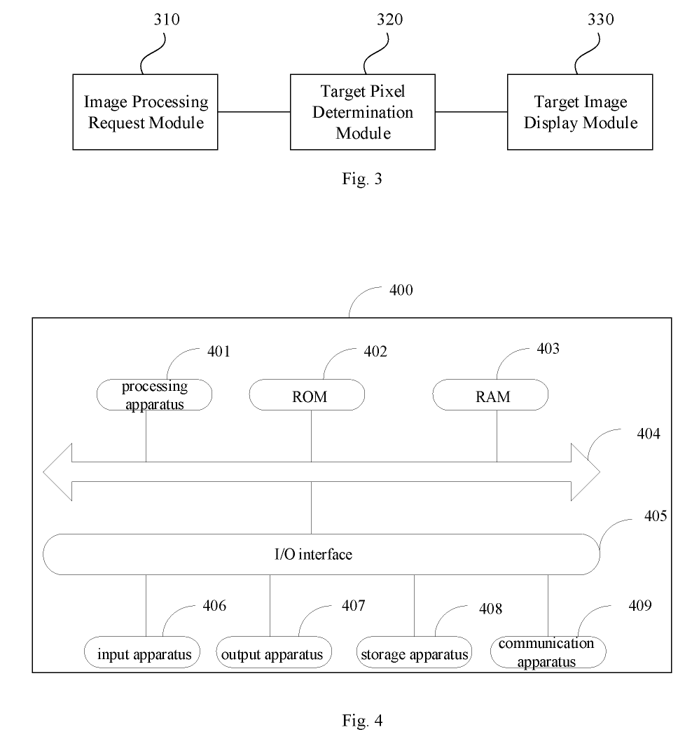

FIG. 3 is a structural schematic diagram of an image processing apparatus provided by an embodiment of the present disclosure. As shown in FIG. 3, the image processing apparatus includes an image processing request module 310, a target pixel determination module 320, and a target image display module 330. The image processing request module is configured to obtain, in response to an image processing request, an image to be processed, wherein the image to be processed includes a target object. The target pixel determination module is configured to determine target distance values from a plurality of image pixels in the image to be processed to an object boundary of the target object, and determine, according to the target distance values, a target pixel corresponding to the target object from the plurality of image pixels. The target image display module is configured to determine, according to a preset color, a shadow pixel value for the target object acting on the target pixel, determine, according to the shadow pixel value corresponding to the target pixel, a target image, and display the target image.

According to the technical solutions of the embodiments of the present disclosure, the image to be processed including the target object is obtained by the image processing request module 310 in response to the image processing request. After the image processing request is received, the image processing flow can be automatically started to obtain the image needing to be processed. By the target pixel determination module 320, the target distance values from the plurality of image pixels in the image to be processed to the object boundary of the target object are then determined, and the target pixel corresponding to the target object is determined from the plurality of image pixels according to the target distance values. The target pixel needing to be added with the shadow effect in the image to be processed can be determined merely by determining the target distance value of the image pixel from the object boundary of the target object in the two-dimensional space. The target pixel can be determined simply, rapidly, and accurately. Finally, by the target image display module 330, the shadow pixel value for the target object acting on the target pixel is determined according to the preset color, and the target image is determined according to the shadow pixel value corresponding to the target pixel and displayed. It is supported that the shadow effect is flexibly set at the target pixel. The target image including the shadow effect is generated. The image display effects are enriched. The technical problems of complex shadow effect generation way, occupation of large internal memory space, low shadow generation efficiency, and the like in the related art are solved. The effects of reducing the shadow generation complexity of the target object, saving the internal memory and the computing power space, expanding the range of application, simplifying the image processing flow, and enhancing the image processing experience are achieved.

On the basis of any optional technical solution in the embodiments of the present disclosure, optionally, the target pixel determination module 320 includes a signed distance field function determination unit configured to: obtain a preset signed distance field function corresponding to the target object; or determine, according to the boundary shape of the target object and a preset shape function, an object boundary function corresponding to the target object, and construct the signed distance field function according to the object boundary function.

On the basis of any optional technical solution in the embodiments of the present disclosure, the signed distance field function determination unit may be specifically configured to, when the object boundary function includes a plurality of preset shape functions, construct, according to each of the preset shape functions, a signed distance field function. Further, the target pixel determination module further includes a target distance value determination unit configured to: determine, according to each signed distance field function, signed distance values from the plurality of image pixels in the image to be processed to the object boundary of the target object; and for a single image pixel, determine, according to the signed distance values corresponding to the plurality of signed distance field functions, the target distance value corresponding to the image pixel.

On the basis of any optional technical solution in the embodiments of the present disclosure, optionally, the signed distance field function determination unit is configured to perform at least one of the following operations: when a preset shape function in conformity with the boundary shape of the target object is obtained, determining the preset shape function as the object boundary function corresponding to the target object; when no preset shape function in conformity with the boundary shape of the target object is obtained, transforming, according to the boundary shape of the target object, the preset shape function to the object boundary function corresponding to the target object by adjusting at least one parameter of the preset shape function; and when no preset shape function in conformity with the boundary shape of the target object is obtained, obtaining the plurality of preset shape functions which are splicable to obtain the boundary shape of the target object, and determining the plurality of preset shape functions as the object boundary function corresponding to the target object.

On the basis of any optional technical solution in the embodiments of the present disclosure, optionally, the target image display module 330 is configured to determine, according to the target distance value corresponding to the target pixel, a shadow weighted value, and determine, according to a display pixel value of the target pixel in the image to be processed, the preset color, and the shadow weighted value, the shadow pixel value for the target object acting on the target pixel.

On the basis of any optional technical solution in the embodiments of the present disclosure, optionally, the target pixel determination module 320 is specifically configured to determine the image pixel corresponding to the target distance value within a preset distance range as the target pixel corresponding to the target object.

On the basis of any optional technical solution in the embodiments of the present disclosure, optionally, the image processing apparatus further includes a pixel distance value determination module. The pixel distance value determination module is specifically configured to, when the image to be processed includes a plurality of target objects and the same target pixel corresponds to the plurality of target objects, after determining, according to the preset color, the shadow pixel value for the target object acting on the target pixel, for the target pixel corresponding to the plurality of target objects, determine a maximum of shadow pixel values for the plurality of target objects acting on the target pixel as the shadow pixel value corresponding to the target pixel, or determine a sum of the shadow pixel values for the target objects acting on the target pixel as the shadow pixel value corresponding to the target pixel.

The image processing apparatus provided by the embodiment of the present disclosure may perform the image processing method provided by any embodiment of the present disclosure and has corresponding functional modules for performing the image processing method and corresponding beneficial effects.

It needs to be noted that the units and modules included in the apparatus described above are only divided according to functional logic, but are not limited to the above division, as long as corresponding functions can be implemented. In addition, names of the functional units are merely for the purpose of distinguishing from each other, but are not intended to limit the protection scope of the embodiments of the present disclosure.

FIG. 4 illustrates a schematic structural diagram of an electronic device 400 provided by an embodiment of the present disclosure. Referring to FIG. 4, FIG. 4 illustrates a schematic structural diagram of an electronic device 400 suitable for implementing some embodiments of the present disclosure. The electronic device 400 in some embodiments of the present disclosure may include but are not limited to mobile terminals such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal), a wearable electronic device or the like, and fixed terminals such as a digital TV, a desktop computer, or the like. The electronic device illustrated in FIG. 4 is merely an example, and should not pose any limitation to the functions and the range of use of the embodiments of the present disclosure.

As illustrated in FIG. 4, the electronic device 400 may include a processing apparatus 401 (e.g., a central processing unit, a graphics processing unit, etc.), which can perform various suitable actions and processing according to a program stored in a read-only memory (ROM) 402 or a program loaded from a storage apparatus 408 into a random-access memory (RAM) 403 to perform various actions and processing to realize the environmental camera configuration method provided by the embodiment of the present disclosure. The RAM 403 further stores various programs and data required for operations of the electronic device 400. The processing apparatus 401, the ROM 402, and the RAM 403 are interconnected by means of a bus 404. An input/output (I/O) interface 405 is also connected to the bus 404.

Usually, the following apparatus may be connected to the I/O interface 405: an input apparatus 406 including, for example, a touch screen, a touch pad, a keyboard, a mouse, a camera, a microphone, an accelerometer, a gyroscope, or the like; an output apparatus 407 including, for example, a liquid crystal display (LCD), a loudspeaker, a vibrator, or the like; a storage apparatus 408 including, for example, a magnetic tape, a hard disk, or the like; and a communication apparatus 409. The communication apparatus 409 may allow the electronic device 400 to be in wireless or wired communication with other devices to exchange data. While FIG. 3 illustrates the electronic device 400 having various apparatuses, it should be understood that not all of the illustrated apparatuses are necessarily implemented or included. More or fewer apparatuses may be implemented or included alternatively.

Particularly, according to some embodiments of the present disclosure, the processes described above with reference to the flowcharts may be implemented as a computer software program. For example, some embodiments of the present disclosure include a computer program product, which includes a computer program carried by a non-transitory computer-readable medium. The computer program includes program codes for performing the methods shown in the flowcharts. In such embodiments, the computer program may be downloaded online through the communication apparatus 409 and installed, or may be installed from the storage apparatus 408, or may be installed from the ROM 402. When the computer program is executed by the processing apparatus 401, the above-mentioned functions defined in the methods of some embodiments of the present disclosure are performed.

Names of messages or information exchanged between a plurality of apparatuses in embodiments of the present disclosure are only used for the purpose of description and not meant to limit the scope of these messages or information.

The electronic device provided by this embodiment of the present disclosure and the table data processing method provided by the foregoing embodiments belong to the same inventive concept. For technical details not described in detail in this embodiment of the present disclosure, reference may be made to the foregoing embodiments, and this embodiment of the present disclosure and the foregoing embodiments have the same beneficial effects.

An embodiment of the present disclosure provides a non-transitory computer storage medium storing a computer program which, when executed by a processor, implements the table data processing method provided by the foregoing embodiments.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program codes. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

According to one or more embodiments of the present disclosure, Example 1 provides an image processing method comprising: obtaining an image to be processed in response to an image processing request, wherein the image to be processed comprises a target object; determining target distance values from a plurality of image pixels in the image to be processed to an object boundary of the target object, and determining a target pixel corresponding to the target object from the plurality of image pixels according to the target distance values; and determining a shadow pixel value for the target object acting on the target pixel according to a preset color, determining a target image according to the shadow pixel value corresponding to the target pixel, and displaying the target image.

According to one or more embodiments of the present disclosure, Example 2 provides the method provide by Example 1, and further comprises: optionally, the determining target distance values from a plurality of image pixels in the image to be processed to an object boundary of the target object comprising: determining a signed distance field function corresponding to the target object, and determining the target distance values from the plurality of image pixels in the image to be processed to the object boundary of the target object according to the signed distance field function, wherein the signed distance field function is associated with a boundary shape of the target object.

According to one or more embodiments of the present disclosure, Example 3 provides the method provide by Example 2, and further comprises: optionally, the determining a signed distance field function corresponding to the target object comprising: obtaining a preset signed distance field function corresponding to the target object; or determining an object boundary function corresponding to the target object according to the boundary shape of the target object and a preset shape function, and constructing the signed distance field function according to the object boundary function.

According to one or more embodiments of the present disclosure, Example 4 provides the method provide by Example 3, and further comprises: optionally, the constructing the signed distance field function according to the object boundary function comprising: when the object boundary function comprises a plurality of preset shape functions, constructing a signed distance field function according to each of the plurality of preset shape functions; and the determining the target distance values from the plurality of image pixels in the image to be processed to the object boundary of the target object according to the signed distance field function comprising: determining signed distance values from the plurality of image pixels in the image to be processed to the object boundary of the target object according to each of the plurality of signed distance field functions; and for each of the plurality of image pixels, determining a target distance value corresponding to the image pixel according to the signed distance values corresponding to the plurality of signed distance field functions.

According to one or more embodiments of the present disclosure, Example 5 provides the method provide by Example 3, and further comprises: optionally, the determining an object boundary function corresponding to the target object according to the boundary shape of the target object and a preset shape function comprising at least one of following operations: in response to obtaining a preset shape function in conformity with the boundary shape of the target object, determining the preset shape function as the object boundary function corresponding to the target object; in response to obtaining no preset shape function in conformity with the boundary shape of the target object, transforming the preset shape function to the object boundary function corresponding to the target object by adjusting at least one parameter of the preset shape function according to the boundary shape of the target object; and in response to obtaining no preset shape function in conformity with the boundary shape of the target object, obtaining a plurality of preset shape functions which are splicable to obtain the boundary shape of the target object, and determining the plurality of preset shape functions as the object boundary function corresponding to the target object.

According to one or more embodiments of the present disclosure, Example 6 provides the method provide by Example 1, and further comprises: optionally, the determining a shadow pixel value for the target object acting on the target pixel according to a preset color comprising: determining a shadow weighted value according to a target distance value corresponding to the target pixel, and determining the shadow pixel value for the target object acting on the target pixel according to a display pixel value of the target pixel in the image to be processed, the preset color, and the shadow weighted value.

According to one or more embodiments of the present disclosure, Example 7 provides the method provide by Example 1, and further comprise: optionally, the determining a target pixel corresponding to the target object from the plurality of image pixels according to the target distance values comprising: determining an image pixel corresponding to the target distance value within a preset distance range as the target pixel corresponding to the target object.

According to one or more embodiments of the present disclosure, Example 8 provides the method provide by Example 1, and further comprises: after the determining a shadow pixel value for the target object acting on the target pixel according to a preset color, the method further comprising: when the image to be processed comprises a plurality of target objects and there is one target pixel corresponding to the plurality of target objects, for the target pixel corresponding to the plurality of target objects, determining a maximum of shadow pixel values for the plurality of target objects acting on the target pixel as the shadow pixel value corresponding to the target pixel, or determining a sum of the shadow pixel values for the target objects acting on the target pixel as the shadow pixel value corresponding to the target pixel.

According to one or more embodiments of the present disclosure, Example 9 provides an image processing apparatus, comprising: an image processing request module configured to obtain, in response to an image processing request, an image to be processed, wherein the image to be processed comprises a target object; a target pixel determination module configured to determine target distance values from a plurality of image pixels in the image to be processed to an object boundary of the target object, and determine, according to the target distance values, a target pixel corresponding to the target object from the plurality of image pixels; and a target image display module configured to determine, according to a preset color, a shadow pixel value for the target object acting on the target pixel, determine, according to the shadow pixel value corresponding to the target pixel, a target image, and display the target image.

In some implementation modes, the client and the server may communicate with any network protocol currently known or to be researched and developed in the future such as hypertext transfer protocol (HTTP), and may communicate (via a communication network) and interconnect with digital data in any form or medium. Examples of communication networks include a local area network (LAN), a wide area network (WAN), the Internet, and an end-to-end network (e.g., an ad hoc end-to-end network), as well as any network currently known or to be researched and developed in the future.

The above-mentioned computer-readable medium may be included in the above-mentioned electronic device, or may also exist alone without being assembled into the electronic device.

The above-mentioned computer-readable medium carries one or more programs, and when the one or more programs are executed by the electronic device, the electronic device is caused to: obtain an image to be processed in response to an image processing request, wherein the image to be processed comprises a target object; determine target distance values from a plurality of image pixels in the image to be processed to an object boundary of the target object, and determine a target pixel corresponding to the target object from the plurality of image pixels according to the target distance values; and determine a shadow pixel value for the target object acting on the target pixel according to a preset color, determine a target image according to the shadow pixel value corresponding to the target pixel, and display the target image.

The computer program codes for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user’s computer, partly on the user’s computer, as a stand-alone software package, partly on the user’s computer and partly on a remote computer, or entirely on the remote computer or server. In the scenario related to the remote computer, the remote computer may be connected to the user’s computer through any type of network, including a local area network (LAN) or a wide area network (WAN), or the connection may be made to an external computer (for example, through the Internet using an Internet service provider).

The flowcharts and block diagrams in the accompanying drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules or units involved in the embodiments of the present disclosure may be implemented in software or hardware. Among them, the name of the module or unit does not constitute a limitation of the unit itself under certain circumstances.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

The foregoing are merely descriptions of the preferred embodiments of the present disclosure and the explanations of the technical principles involved. It will be appreciated by those skilled in the art that the scope of the disclosure involved herein is not limited to the technical solutions formed by a specific combination of the technical features described above, and shall cover other technical solutions formed by any combination of the technical features described above or equivalent features thereof without departing from the concept of the present disclosure. For example, the technical features described above may be mutually replaced with the technical features having similar functions disclosed herein (but not limited thereto) to form new technical solutions.

In addition, while operations have been described in a particular order, it shall not be construed as requiring that such operations are performed in the stated specific order or sequence. Under certain circumstances, multitasking and parallel processing may be advantageous. Similarly, while some specific implementation details are included in the above discussions, these shall not be construed as limitations to the present disclosure. Some features described in the context of a separate embodiment may also be combined in a single embodiment. Rather, various features described in the context of a single embodiment may also be implemented separately or in any appropriate sub-combination in a plurality of embodiments.

Although the present subject matter has been described in a language specific to structural features and/or logical method acts, it will be appreciated that the subject matter defined in the appended claims is not necessarily limited to the particular features and acts described above. Rather, the particular features and acts described above are merely exemplary forms for implementing the claims.

1. An image processing method, comprising:
obtaining an image to be processed in response to an image processing request, wherein the image to be processed comprises a first object;
determining first distance values from a plurality of image pixels in the image to be processed to an object boundary of the first object, and determining a first pixel corresponding to the first object from the plurality of image pixels according to the first distance values; and
determining a shadow pixel value for the first object acting on the first pixel according to a preset color, determining a first image according to the shadow pixel value corresponding to the first pixel, and displaying the first image.

2. The image processing method according to claim 1, wherein the determining first distance values from a plurality of image pixels in the image to be processed to an object boundary of the first object comprises:
determining a signed distance field function corresponding to the first object, and
determining the first distance values from the plurality of image pixels in the image to be processed to the object boundary of the first object according to the signed distance field function, wherein the signed distance field function is associated with a boundary shape of the first object.

3. The image processing method according to claim 2, wherein the determining a signed distance field function corresponding to the first object comprises:
obtaining a preset signed distance field function corresponding to the first object; or
determining an object boundary function corresponding to the first object according to the boundary shape of the first object and a preset shape function, and constructing the signed distance field function according to the object boundary function.

4. The image processing method according to claim 3, wherein the constructing the signed distance field function according to the object boundary function comprises: when the object boundary function comprises a plurality of preset shape functions, constructing a signed distance field function according to each of the plurality of preset shape functions; and
the determining the first distance values from the plurality of image pixels in the image to be processed to the object boundary of the first object according to the signed distance field function comprises:
determining signed distance values from the plurality of image pixels in the image to be processed to the object boundary of the first object according to each of the plurality of signed distance field functions; and
for each of the plurality of image pixels, determining a first distance value corresponding to the image pixel according to the signed distance values corresponding to the plurality of signed distance field functions.

5. The image processing method according to claim 3, wherein the determining an object boundary function corresponding to the first object according to the boundary shape of the first object and a preset shape function comprises at least one of following operations:
in response to obtaining a preset shape function in conformity with the boundary shape of the first object, determining the preset shape function as the object boundary function corresponding to the first object;
in response to obtaining no preset shape function in conformity with the boundary shape of the first object, transforming the preset shape function to the object boundary function corresponding to the first object by adjusting at least one parameter of the preset shape function according to the boundary shape of the first object; and
in response to obtaining no preset shape function in conformity with the boundary shape of the first object, obtaining a plurality of preset shape functions which are splicable to obtain the boundary shape of the first object, and determining the plurality of preset shape functions as the object boundary function corresponding to the first object.

6. The image processing method according to claim 1, wherein the determining a shadow pixel value for the first object acting on the first pixel according to a preset color comprises:
determining a shadow weighted value according to a first distance value corresponding to the first pixel, and
determining the shadow pixel value for the first object acting on the first pixel according to a display pixel value of the first pixel in the image to be processed, the preset color, and the shadow weighted value.

7. The image processing method according to claim 1, wherein the determining a first pixel corresponding to the first object from the plurality of image pixels according to the first distance values comprises:
determining an image pixel corresponding to a first distance value within a preset distance range as the first pixel corresponding to the first object.

8. The image processing method according to claim 1, after the determining a shadow pixel value for the first object acting on the first pixel according to a preset color, further comprising:
when the image to be processed comprises a plurality of first objects and there is one first pixel corresponding to the plurality of first objects, for the first pixel corresponding to the plurality of first objects, determining a maximum of shadow pixel values for the plurality of first objects acting on the first pixel as the shadow pixel value corresponding to the first pixel, or determining a sum of the shadow pixel values for the first objects acting on the first pixel as the shadow pixel value corresponding to the first pixel.

9. An electronic device, comprising:
one or more processors; and
a storage apparatus configured to store one or more programs,
wherein the one or more programs, when executed by the one or more processors, cause the one or more processors to implement an image processing method comprising:
obtaining an image to be processed in response to an image processing request, wherein the image to be processed comprises a first object;
determining first distance values from a plurality of image pixels in the image to be processed to an object boundary of the first object, and determining a first pixel corresponding to the first object from the plurality of image pixels according to the first distance values; and
determining a shadow pixel value for the first object acting on the first pixel according to a preset color, determining a first image according to the shadow pixel value corresponding to the first pixel, and displaying the first image.

10. The electronic device according to claim 9, wherein the determining first distance values from a plurality of image pixels in the image to be processed to an object boundary of the first object comprises:
determining a signed distance field function corresponding to the first object, and
determining the first distance values from the plurality of image pixels in the image to be processed to the object boundary of the first object according to the signed distance field function, wherein the signed distance field function is associated with a boundary shape of the first object.

11. The electronic device according to claim 10, wherein the determining a signed distance field function corresponding to the first object comprises:
obtaining a preset signed distance field function corresponding to the first object; or
determining an object boundary function corresponding to the first object according to the boundary shape of the first object and a preset shape function, and constructing the signed distance field function according to the object boundary function.

12. The electronic device according to claim 11, wherein the constructing the signed distance field function according to the object boundary function comprises: when the object boundary function comprises a plurality of preset shape functions, constructing a signed distance field function according to each of the plurality of preset shape functions; and
the determining the first distance values from the plurality of image pixels in the image to be processed to the object boundary of the first object according to the signed distance field function comprises:
determining signed distance values from the plurality of image pixels in the image to be processed to the object boundary of the first object according to each of the plurality of signed distance field functions; and
for each of the plurality of image pixels, determining a first distance value corresponding to the image pixel according to the signed distance values corresponding to the plurality of signed distance field functions.

13. The electronic device according to claim 11, wherein the determining an object boundary function corresponding to the first object according to the boundary shape of the first object and a preset shape function comprises at least one of following operations:
in response to obtaining a preset shape function in conformity with the boundary shape of the first object, determining the preset shape function as the object boundary function corresponding to the first object;
in response to obtaining no preset shape function in conformity with the boundary shape of the first object, transforming the preset shape function to the object boundary function corresponding to the first object by adjusting at least one parameter of the preset shape function according to the boundary shape of the first object; and
in response to obtaining no preset shape function in conformity with the boundary shape of the first object, obtaining a plurality of preset shape functions which are splicable to obtain the boundary shape of the first object, and determining the plurality of preset shape functions as the object boundary function corresponding to the first object.

14. The electronic device according to claim 9, wherein the determining a shadow pixel value for the first object acting on the first pixel according to a preset color comprises:
determining a shadow weighted value according to a first distance value corresponding to the first pixel, and
determining the shadow pixel value for the first object acting on the first pixel according to a display pixel value of the first pixel in the image to be processed, the preset color, and the shadow weighted value.

15. The electronic device according to claim 9, wherein the determining a first pixel corresponding to the first object from the plurality of image pixels according to the first distance values comprises:
determining an image pixel corresponding to a first distance value within a preset distance range as the first pixel corresponding to the first object.

16. The electronic device according to claim 9, after the determining a shadow pixel value for the first object acting on the first pixel according to a preset color, further comprising:
when the image to be processed comprises a plurality of first objects and there is one first pixel corresponding to the plurality of first objects, for the first pixel corresponding to the plurality of first objects, determining a maximum of shadow pixel values for the plurality of first objects acting on the first pixel as the shadow pixel value corresponding to the first pixel, or determining a sum of the shadow pixel values for the first objects acting on the first pixel as the shadow pixel value corresponding to the first pixel.

17. A non-transitory storage medium comprising computer-executable instructions, wherein the computer-executable instructions, when executed by a computer processor, are configured to perform an image processing method comprising:
obtaining an image to be processed in response to an image processing request, wherein the image to be processed comprises a first object;
determining first distance values from a plurality of image pixels in the image to be processed to an object boundary of the first object, and determining a first pixel corresponding to the first object from the plurality of image pixels according to the first distance values; and
determining a shadow pixel value for the first object acting on the first pixel according to a preset color, determining a first image according to the shadow pixel value corresponding to the first pixel, and displaying the first image.
